(19) United States
(12) Patent Application Publication
(10) Pub. No.: US 2001/0005201 A1
(43) Pub. Date: Jun. 28, 2001

(54) A COMPUTER SYSTEM USING A PROCESSOR INTERFACING WITH MULTIPLE DISPLAYS

(76) Inventors: RINALDO DIGIORGIO, PALO ALTO, CA (US); MICHAEL BENDER, BOULDER CREEK, CA (US)

Correspondence Address: THE HECKER LAW GROUP, 1925 CENTURY PARK EAST, SUITE 2300, LOS ANGELES, CA, 90067, US

(21) Appl. No.: 09/108,065

(22) Filed: Jun. 30, 1998

(51) Int. Cl. G09G 5/00

(52) U.S. Cl. 345/204

(57) ABSTRACT

The present invention comprises a distributed display panel that accepts personal computing devices. The personal computing device can drive the distributed display panel so that the combination functions as a computer terminal. The CPU is not in the distributed display panel but in the portable computing device carried by the user. This approach allows the user to effectively carry computer in the user's pocket and use generic services on the computer network. The distributed display panel device consists of memory and an interface to an external port into which the personal computing device can be inserted. Once the personal computing device is inserted the personal computing device is recognized and connections are made to the distributed display panel and to a network. From this point computing is performed on the personal computing device. Since the CPU of the personal computing device is known and trusted (since it belongs to the user) the computing environment is highly trusted. The distributed display panel comprises a display such as an LCD type display, a reading device for receiving data from the personal computing device, and a bus interface to the personal computing device. The personal computing device includes a CPU, memory, and, in one embodiment, a platform independent computing environment, such as implemented in the JAVAT™ programming language.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever. Sun, Sun Microsystems, the Sun logo, Solaris, “Write Once, Run Anywhere”, Java, JavaOS, JavaStation, HotJava Views and all Java-based trademarks and logos are trademarks or registered trademarks of Sun Microsystems, Inc. in the United States and other countries.

### BACKGROUND OF THE INVENTION

The present invention relates generally to computer systems and particularly to a computer system comprising a plurality of readily separable components.

Computer users desire to have computer access at numerous locations and while traveling. Current portable and remote computing solutions have a number of disadvantages and limitations.

Portable computers, or so called “lap top” computers, suffer from size and weight limitations. Even though advances have been made in reducing the size and weight of these components, there are limitations to the dimensions of these components while still making the components usable. These limitations are pronounced in display and keyboard components. To provide an adequate computing experience, portable computers require a relatively large display. Even with flat panel technology, the display still substantially defines the footprint of the portable computer. In addition, there is a limit to the size of the keyboard and closeness of the keys on a portable computer while still allowing comfortable and rapid data entry. Thus, there is a minimum size below which portable computers become impractical. But at that minimum size, portable computers still can not be used or taken everywhere a computer user may desire.

One prior art attempt to provide more mobile computing than may be provided by a portable computer is remote computing. One type of remote computing consists of carrying only software and data between computing locations. For example, Some users desire to use a computer at the office and at home. These users may utilize a desktop computer system at each location, and transport necessary data and files from one location to another on a transportable media. Such transportable media may include floppy disks, removable storage cartridges, or entire disk drive subsystems that can be attached to either the home computer or the office computer. This system has its disadvantages as well. For example, the user is limited to computing at two locations, eliminating all portability. In addition, the disks and/or disk drives may be of such size to preclude comfortable transporting, with a case or briefcase still required.

Another type of remote computing has a computer user accessing a host computer through a computer network. A user may dial up the user's host computer directly, or access a company computer network from an outside or remote computer. This requires an authenticated connection to be established to prevent unauthorized users from accessing protected networks. In addition, the system may require that the access be made from a specific type of computer platform, with specific operating systems, minimum clock speeds, and minimum memory requirements. Such a computer may not always be available at the location of the remote computer user. Further, such a computing experience may be compromised by network bandwidth limitations.

U.S. Pat. No. 5,651,109 is directed to a terminal device that identifies its type to a server computer so that menus and cursor position information can be accurately displayed on the terminal and terminal devices with different operating characteristics may successfully communicate with a host computer even though the terminals may have different screen sizes or capabilities.

### SUMMARY OF THE INVENTION

The present invention comprises a distributed display panel that accepts personal computing devices to provide a computing environment. The personal computing device can drive the distributed display panel so that the combination functions as a computer terminal. The CPU is not in the distributed display panel but in the portable computing device carried by the user. This approach allows the user to effectively carry computer in the user's pocket and use generic services on the computer network.

The distributed display panel device consists of memory and an interface to an external port into which the personal computing device can be inserted. Once the personal computing device is inserted the personal computing device is recognized and connections are made to the distributed display panel and to a network. From this point computing is performed on the personal computing device. Since the CPU of the personal computing device is known and trusted (since it belongs to the user) the computing environment is highly trusted.

The distributed display panel comprises a display such as an LCD type display, a reading device for receiving data from the personal computing device, and a bus interface to the personal computing device.

The personal computing device includes a CPU, memory, and, in one embodiment, a platform independent computing environment, such as implemented in the JAVA™ programming language.

A user can use a distributed display panel by being in proximity to it with a personal computing device or by inserting the personal computing device for security and performance reasons. Once the distributed display panel is in communication with the personal computing device, the personal computing device drives the display device and interfaces to the user. Since the CPU is on the personal computing device, this type of architecture means that personal data never has to leave the computer and is not in danger of being left behind when the computing session is finished.

### BRIEF DESCRIPTION OF THE DRAWINGS

FIG. 1 is a perspective view diagram illustrating a distributed display panel and computer cards according to one embodiment of the present invention.

FIG. 2 is a block diagram illustrating one embodiment of the present invention.

FIG. 3 is a block diagram illustrating one embodiment of the present invention.

### DETAILED DESCRIPTION OF THE INVENTION

A computer system comprising a plurality of readily separable components is described. In the following description, numerous specific details are set forth in order to provide a more thorough understanding of the present invention. It will be apparent, however, to one skilled in the art, that the present invention may be practiced without these specific details. In other instances, well-known features have not been described in detail in order not to unnecessarily obscure the present invention.

The present invention provides a new paradigm for mobile and remote computing by separating display and keyboard functionality from processing functionality and personal data storage. The present invention contemplates a plurality of distributed display panels at homes, offices, public buildings, commercial sites, on public transportation, airplanes, and other locations. The distributed display panels may be provided by individuals, companies, commercial enterprises, or the public sector. The distributed display panels provide display functionality, keyboards, and, when desired, network connectivity. The distributed display panels may be fixed in some locations. In other cases, distributed display panels are themselves portable as appropriate. Nevertheless, the distributed display panels are designed to provide a computing experience when enabled by their combination with a personal computing device. (Note that if desired, the distributed display panels may include local processing and memory. When a commercial enterprise provides distributed display panels, the enterprise may desire that some advertising or other purpose directed computing functionality be provided in addition to personal computing, as a way of subsidizing the cost of providing the distributed display panels.)

Computer users wishing to take advantage of the distributed display panels to provide a computing experience carry a personal computing device that can be used to activate the distributed display panel and provide the processing power to drive the display. The combination of the personal computing device and the distributed display panel yields a functioning computer system. The personal computing device includes memory, a CPU, and personal information needed to authorize a secure transaction with a user network. In practice, a user can approach any of the plurality of distributed display panels, activate it with the user's personal computing device, and begin a computing session.

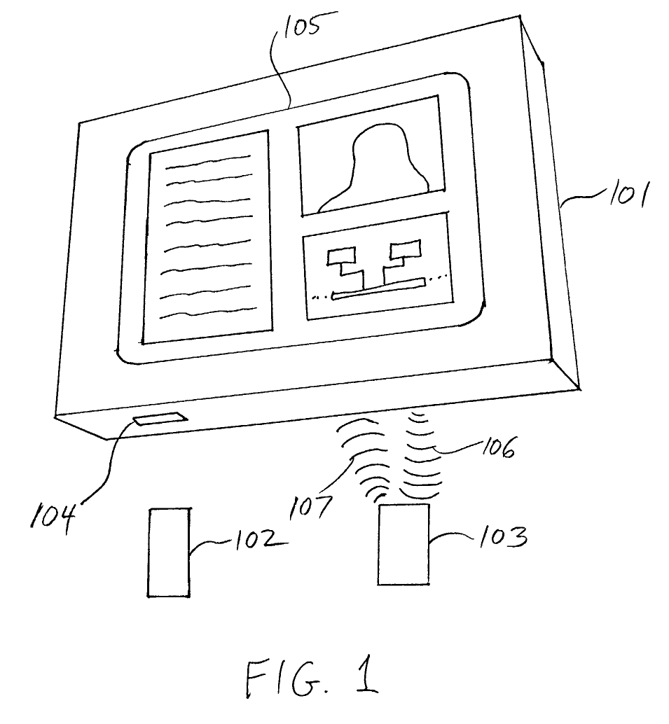

FIG. 1 illustrates one embodiment of the present invention. A distributed display panel 110 includes a display region 105. The distributed display panel includes a slot 104 that can receive the personal computing device 102. Alternatively, a personal computing device 103 that communicates wirelessly with the distributed display panel 101 is provided. The wireless personal computing device 103 receives 106 and transmits 107 information to the distributed display panel 101. The distributed display panel 101 may contain interfaces for either or both contact or contactless activation. Although not shown in FIG. 1, a keyboard or other data entry device may be connected to the distributed display panel 101. Upon activation, the distributed display panel may also provide a means of connecting to a network.

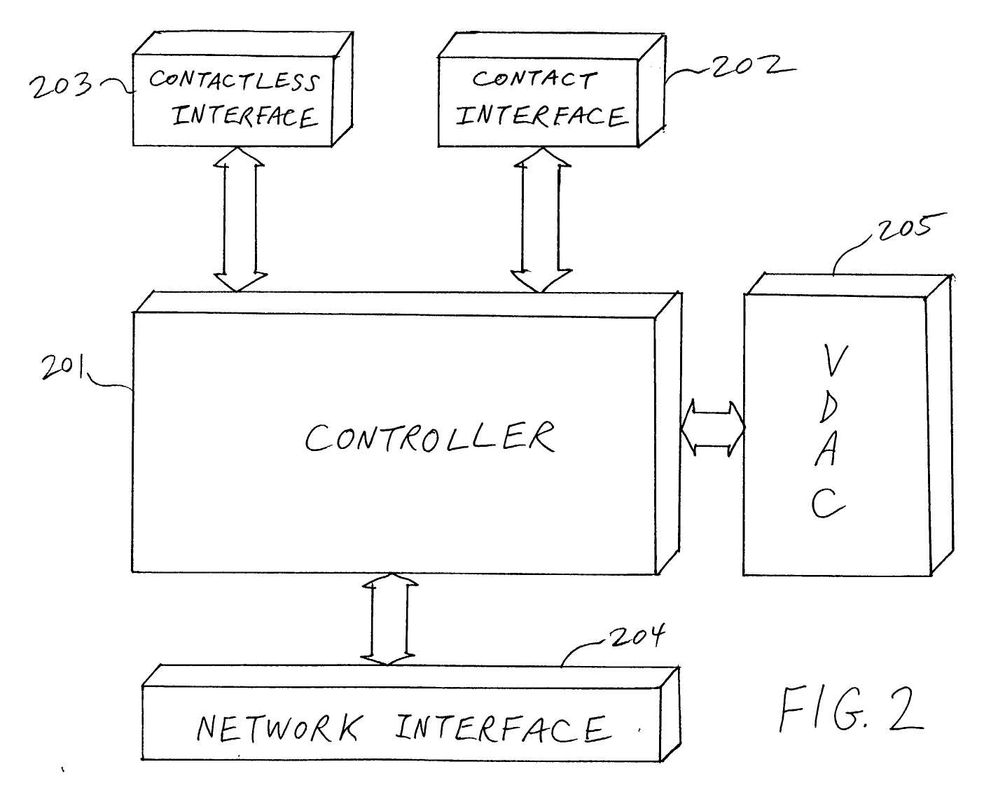

FIG. 2 illustrates a block diagram of one embodiment of the distributed display panel of the present invention. A contact interface 202 and contactless interface 203 communicate to controller block 201. Controller block 201 is coupled to network interface 204 and VDAC 205. The controller block 201 communicates with a personal computing device through one of the interfaces 202 and 203. The controller accesses a network through network interface 204 and drives an attached display through VDAC 205.

### DISTRIBUTED DISPLAY PANEL

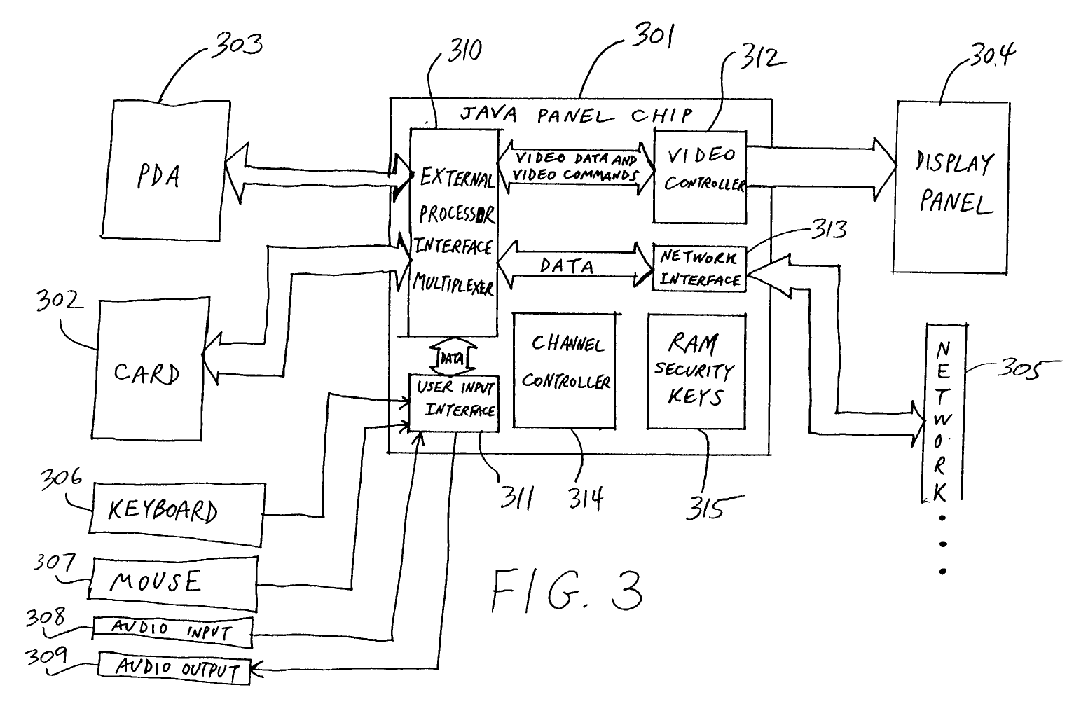

A more detailed illustration of an embodiment of the invention is illustrated in FIG. 3. The distributed display panel chip 301, referred to as the “Java Panel Chip” in FIG. 3 includes an external processor interface multiplexer 310, user input interface 311, video controller 312, network interface 313, channel controller 314 and RAM security keys 315.

Internally, the interface multiplexer 310 communicates video data and video commands bidirectionally with video controller 312 and data bidirectionally with network interface 313. Interface multiplexer 310 also communicates data bidirectionally with user input interface 311. Externally, interface multiplexer 310 communicates with a personal computing device. The personal computing device can be embodied as a personal digital assistant (PDA) such as PDA 303 or with a personal computing device embodied as a “smart card”. Regardless of whether the personal computing device is embodied as a PDA or as a smart card, the communication with the panel chip 301 can be via contact or non contact mechanisms.

The panel chip, and correspondingly, the distributed display panel 101 itself, can permanently include, or temporarily couple to, user input/output devices such as keyboard 306, mouse 307, audio input 308, or audio output 309. Although a mouse 307 is illustrated in FIG. 3, any cursor positioning or pointing device may be implemented, including tablets, trackballs, or others. In addition, the display screen itself may include touch sensitive devices to operate as a touch screen, or as a pen based input system. Alternatively, the input devices can permanently or temporarily couple to the personal computing device.

In the embodiment of FIG. 3, user input/output is provided to panel chip 301 through user input interface 311. Interface 311 then communicates the input/output data to the interface multiplexer 310. Interface multiplexer 310 transfers data to the video controller to drive distributed display panel 304. In some cases, the user may communicate through a network as part of the computing experience. Interface multiplexer 310 transmits data from the personal computing device through network interface 313 to a network 305. The connection to the network 305 may be via a telephone connection, or through any other means, including a carrier wave implementation.

RAM security keys 315 can be used to temporarily hold authorization information for implementing secure network transactions.

The panel chip, and consequently, the distributed display panel, has two modes of operation. These modes are referred to here as network mode and local mode. The network mode is for cases where the personal computing device is not powerful enough to drive a megapixel display on its own. In local mode, the personal computing device generates data for the display.

Local Mode—In local mode, a user inserts (or otherwise brings into proximity) a personal computing device with the distributed display panel. The distributed display panel detects the presence of the personal computing device and enables a command channel which understands the distributed display panel external protocol. The personal computing device initializes this mode by requesting a network connection, possibly using some of the user's personal data. Once the connection is established, the application on a network server is instructed to send data certain port. The distributed display panel includes sufficient intelligence to decode the stack and route data directly to the video controller. The stream has requests for input embedded in it.

Network Mode—A user activates the distributed display panel with a personal computing device and sends the appropriate commands to establish a video connection with the distributed display panel and a connection to a network. The personal computing device can communicate directly with the network and the panel, creating video stream and sending data directly to the network.

Distributed display panel External Protocol—The distributed display panel external protocol defines how communication occurs between the distributed display panel and the personal computing device. Examples of some commands include:

Establish MPEG2 channel with distributed display panel.

Get user input.

Send data to network device.

Get device properties.

Route all data from network server to the display with periodic changes.

Distributed display panel Validation—In some cases, it is important for the distributed display panel to be trusted. The panel contains a unique ID that is validated with a server on the network so that the user knows that this is a registered panel. (It is up to the user to decide if they trust the service that registers the panel). An authentication scheme, such as PGP, may be supported so that a “signer” of the panel may be determined.

### PERSONAL COMPUTING DEVICE

The personal computing device of the present invention may be implemented in a number of ways. The personal computing device could be implemented as a smart card such as is well known in the art. The smart card could have its own power supply, such as a battery, or be powered by the distributed display panel. Another embodiment of the personal computing device is as a “Java Ring” personal computing device such as made by Sun Microsystems, Inc. The present invention avoids the problems associated with various platforms by implementing a platform independent computing language such as the Java™ platform independent computing language. In this manner, regardless of the underlying platform and operating system, the personal computing device should be able to operate any distributed display panel in the system. The personal computing device may communicate with the distributed display panel using any of many different types of physical interfaces. This include, but are not limited to, USB Universal Serial Bus, Fire Wire, RS-422, Optical, Infrared, and RF.

### IMPLEMENTATIONS

One embodiment of the invention contemplates a personal computing device that permits a computing session to be initiated. Other embodiments may be use specific. For example, the personal computing device could be used to receive user specified data (e.g. news and information) and be loaded with such data at a home or office computer system. The user could then carry the personal computing device and access it at a distributed display panel to read a custom “newspaper”. The personal computing device could be in the form of disposable or recyclable smart cards and come preloaded with data such as newspaper or magazine information, or even books. Although an embodiment illustrating a computing experience is described, the invention has equal application to the user of a distributed display panel as a telephone or other communication device, banking terminal, kiosk for traveler's directions and other uses.

### Java™ Programming and Execution

An embodiment of the software apparatus of the invention is implemented in the Java™ programming language. The Java™ programming language is an object-oriented programming language with each program comprising one or more object classes and interfaces. Unlike many programming languages, in which a program is compiled into machine-dependent, executable program code, Java™ classes are compiled into machine independent bytecode class files. Each class contains code and data in a platform-independent format called the class file format. The computer system acting as the execution vehicle supports the Java™ runtime environment. The runtime environment contains a program called a virtual machine, which is responsible for executing the code in Java™ classes.

Applications may be designed as standalone Java™ applications, or as Java™ “applets” which are identified by an applet tag in an HTML (hypertext markup language) document, and loaded by a browser application. The class files associated with an application or applet may be stored on the local computing system, or on a server accessible over a network. Each class is loaded into the runtime environment, as needed, by the “class loader.”

The classes of an applet are loaded on demand from the network (stored on a server), or from a local file system, when first referenced during the applet's execution. The runtime environment locates and loads each class file, parses the class file format, allocates memory for the class's various components, and links the class with other already loaded classes. This process makes the code in the class readily executable by the virtual machine.

Java™ class files are often identified in applet tags within an HTML (hypertext markup language) document. To provide a client with access to class files from a server on a network, a web server application is executed on the server to respond to HTTP (hypertext transport protocol) requests containing URLs (universal resource locators) to HTML documents, also referred to as “web pages.” When a browser application executing on a client platform receives an HTML document (e.g., as a result of requesting an HTML document by forwarding a URL to the web server), the browser application parses the HTML and automatically initiates the download of the bytecode class files 202 when it encounters the applet tag in the HTML document.

Memory is allocated to store and execute the downloaded applet. The allocation of memory to new applets may lead to a low memory condition as the number of applets in the Java™ runtime environment grows. To resolve the low memory condition, older, invisible applets (i.e., applets that are not currently visible on a display) may be unloaded, or “destroyed” (i.e., shutdown and de-allocated), to release memory. An applet thus destroyed can no longer enact user notification functions when events occur that are relevant to the destroyed applet.

With the popularity of network systems, such as the World Wide Web, there is a need to provide more compatibility of computer and non-computer platforms to the Web. The Java language developed by Sun JavaSoft has provided a way to write platform independent applications to run on the Web and provide the desired compatibility. Some platforms may have unique and/or proprietary interfaces, limited memory and display sizes, constrained power consumption, user response time, and limited physical space. These platform are referred to here as restrictive environments. A version of Java called “PersonalJava” has been developed by JavaSoft to be used with, among other things, restrictive environments. A description of Java and PersonalJava can be found at web site “http://www.java.sun.com”.

### Object-Oriented Programming

Object-oriented programming is a method of creating computer programs by combining certain fundamental building blocks, and creating relationships among and between the building blocks. The building blocks in object-oriented programming systems are called “objects.” An object is a programming unit that groups together a data structure (one or more instance variables) and the operations (methods) that can use or affect that data. Thus, an object consists of data and one or more operations or procedures that can be performed on that data. The joining of data and operations into a unitary building block is called “encapsulation.”

An object can be instructed to perform one of its methods when it receives a “message.” A message is a command or instruction sent to the object to execute a certain method. A message consists of a method selection (e.g., method name) and a plurality of arguments. A message tells the receiving object what operations to perform.

One advantage of object-oriented programming is the way in which methods are invoked. When a message is sent to an object, it is not necessary for the message to instruct the object how to perform a certain method. It is only necessary to request that the object execute the method. This greatly simplifies program development.

Object-oriented programming languages are predominantly based on a “class” scheme. The class-based object-oriented programming scheme is generally described in Lieberman, “Using Prototypical Objects to Implement Shared Behavior in Object-Oriented Systems,” OOPSLA 86 Proceedings, September 1986, pp. 214-223.

A class defines a type of object that typically includes both variables and methods for the class. An object class is used to create a particular instance of an object. An instance of an object class includes the variables and methods defined for the class. Multiple instances of the same class can be created from an object class. Each instance that is created from the object class is said to be of the same type or class.

To illustrate, an employee object class can include “name” and “salary” instance variables and a “set_salary” method. Instances of the employee object class can be created, or instantiated for each employee in an organization. Each object instance is said to be of type “employee.” Each employee object instance includes “name” and “salary” instance variables and the “set_salary” method. The values associated with the “name” and “salary” variables in each employee object instance contain the name and salary of an employee in the organization. A message can be sent to an employee's employee object instance to invoke the “set_salary” method to modify the employee's salary (i.e., the value associated with the “salary” variable in the employee's employee object).

A hierarchy of classes can be defined such that an object class definition has one or more subclasses. A subclass inherits its parent's (and grandparent's etc.) definition. Each subclass in the hierarchy may add to or modify the behavior specified by its parent class. Some object-oriented programming languages support multiple inheritance where a subclass may inherit a class definition from more than one parent class. Other programming languages support only single inheritance, where a subclass is limited to inheriting the class definition of only one parent class. The Java™ programming language also provides a mechanism known as an “interface” which comprises a set of constant and abstract method declarations. An object class can implement the abstract methods defined in an interface. Both single and multiple inheritance are available to an interface. That is, an interface can inherit an interface definition from more than one parent interface.

An object is a generic term that is used in the object-oriented programming environment to refer to a module that contains related code and variables. A software application can be written using an object-oriented programming language whereby the program's functionality is implemented using objects.

### IMPLEMENTATION

In one embodiment, display components are written in the Java™ language, without window-system-specific code. In particulary, one embodiment of the invention uses Java Foundation Classes (JFC). JFC extends the original Java™ programming language by adding a comprehensive set of graphical user interface class libraries that is completely portable and delivered as part of the Java platform. JFC's features include a rich suite of high-level components and services that are fully and uniquely cross-platform compatible, and offer significant performance improvements. With the JFC, developers can create and deploy large scale, mission-critical intranet, Internet and Crossware applications. One portion of the JFC, referred to as “Swing”, is particularly suited to the development of GUIs and customizable look and feel applications without relying on the native windowing system, and simplifies the deployment of applications. An API for swing classes is found at “http://web3.javasoft.com/products/jfc/swingdoc-api/com/sun/java/swing/package-summary.html” and is incorporated herein by reference.

Thus, a computer system comprising readily separable components has been described.

1. A system comprising:
a display subsystem;
a processor subsystem separable from said display subsystem;
an interface for communication between said display subsystem and said processor subsystem.

2. The system of claim 1 further comprising:
a user input subsystem coupled to said interface, said user input subsystem for receiving user input.

3. The system of claim 1 wherein said processor subsystem comprises a personal computing device.

4. The system of claim 3 wherein said personal computing device comprises a personal digital assistant.

5. The system of claim 3 wherein said personal computing device comprises a smart card.

6. The system of claim 1 wherein said display subsystem comprises a display panel and controller.

7. The system of claim 6 wherein said control block comprises a data multiplexer coupled to a video controller, said video controller coupled to said display panel.

8. The system of claim 7 wherein said controller further includes a network interface.

9. The system of claim 1 wherein said interface is a contactless interface.

10. The system of claim 1 wherein said interface is a contact interface.
